(19) United States
(12) Patent Application Publication
(10) Pub. No.: US 2005/0221149 A1
(43) Pub. Date: Oct. 6, 2005

(54) Fuel cell stack

(75) Inventors: Takaaki Matsubayashi, Ora-gun (JP); Akira Hamada, Ashikaga-City (JP); Hirokazu Izaki, Ashikaga-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/085,551

(22) Filed: Mar. 22, 2005

(30) Foreign Application Priority Data
Mar. 30, 2004 (JP) 2004-100975
Mar. 30, 2004 (JP) 2004-100976

(51) Int. Cl. H01M 8/02; H01M 8/04; H01M 8/10

(52) U.S. Cl. 429/37; 429/26; 429/38; 429/32

(57) ABSTRACT

In a polymer electrolyte fuel cell stack, cooling water which is used to cool a cell and which flows through a cooling water emission manifold is made to flow into an end plate and into a practically sigmoidal contiguous stack end passage provided in an upper area of the end plate corresponding to a high-temperature area of the cell. The temperature of cooling water flowing from a cell at the stack end to the cooling water emission manifold is maintained constant by a flow rate control element.

### BACKGROUND OF THE INVENTION

1. Field of the Invention

The present invention relates to a fuel cell stack and, more particularly, to a fuel cell stack in which cell temperature is optimized.

2. Description of the Related Art

Generally, a polymer electrolyte fuel cell stack includes a stack of cells. A membrane and electrolyte assembly (hereinafter, referred to as a MEA) is built by bonding an anode to one face of a solid polymer membrane and bonding a cathode to the other face. An anode plate, provided with a fuel passage facing the anode of the MEA, and a cathode plate, provided with an oxidant passage facing the cathode of the MEA, sandwich the assembly so as to form a cell. The stack comprises a plurality of cells with cooling plates interposed between the cells. The fuel cell stack is completed by clamping the stack using end plates provided at respective ends of the stack.

The polymer electrolyte fuel cell stack generates a direct current power from an electrochemical reaction mediated by the electrolyte membrane, by causing a fuel gas such as a reformed gas to flow to the anode plate and causing an oxidant gas such as air to flow to the cathode plate. Since an electrochemical reaction is an exothermic reaction, a normal operating temperature (for example, approximately 70-80° C.) of the polymer electrolyte fuel cell stack is maintained by causing cooling water to flow in the cooling plates so as to cool the cells.

In the polymer electrolyte fuel cell stack, the cells at the stack ends facing the end plates are most affected by external atmosphere. For this reason, the temperature of the cells at the stack ends tends to be lower than that of the other cells. When the cell temperature drops, water vapor in the reactant gas flowing in the passage in the anode plate and in the cathode plate is likely to be condensed inside the passage, resulting in more condensed water produced in the passage in the cells at the stack ends than in other cells. As a result, the flow resistance in the cells at the stack ends grows larger than in the other cells, causing the flow rate of the reactant gas to be decreased and causing the performance of the cell to drop.

In view of these circumstances, a technology for preventing a drop in temperature in the cells at the ends of the solid fuel cell stack is demanded. In a known technology to address this, a passage for causing cooling water to flow is provided in the end plates at the respective end plates. Cooling water, which has its temperature raised to a level close to the operating temperature and which is emitted subsequent to a power generation reaction, is supplied to the passage provided on the entirety of the end plates so that the cells at the stack ends are heated (for example, the related patent document No. 1).

Related Document No. 1 Japanese Published Patent Application No. 2001-68141

Generally, temperature distribution is created in a cell as a result of the flow of cooling water in the cooling plate. Cooling water just supplied to the cooling plate cools the cell efficiently. As the water continues to flow in the cooling plate and the temperature of cooling water is increased, the effect of cooling the cell weakens. For this reason, temperature gradient is created in a direction of flow of cooling water. The phrase “direction of flow of cooling water” does not refer to the direction itself of the cooling water passage provided in the cooling plate but a direction from an inlet of the cooling water passage toward an outlet thereof.

By allowing cooling water emitted from the cooling plate to flow in the passage provided on the entirety of the end plates, as in the related art, the cells at the stack ends are heated uniformly. With this, there is created a difference between temperature gradient in the cells at the stack ends and in the other cells. As a result of this, the portion where condensed water is produced in the cells at the stack ends differs from the corresponding portion in the other cells, causing a voltage generated by the polymer electrolyte fuel cell to become unstable so that it is difficult to ensure stable operation of the polymer electrolyte fuel cell.

### SUMMARY OF THE INVENTION

The present invention has been done in view of the aforementioned circumstances and its object is to provide a fuel cell stack capable of appropriately heating the cells at the stack ends in order to operate a fuel cell in a stable manner.

The fuel cell stack according to one aspect of the present invention comprises: a stack comprising a plurality cells and a plurality of cooling plates each provided with a heat medium passage in which a heat medium for cooling the cell flows, each of the plurality of cells including: a membrane and electrode assembly provided with an electrolyte, an anode provided at one face of the electrolyte, and a cathode provided at the other face of the electrolyte; an anode plate provided with a fuel passage facing the anode; and a cathode plate provided with an oxidant passage facing the cathode, and an end plate provided at an end of the stack via a current collector plate and an insulating plate, so as to clamp the stack; and a stack end passage which is provided in an area of the end plate corresponding to a high-temperature area of the cell, and through each of which the heat medium past the cooling plate flows.

The fuel cell stack according to another aspect of the present invention comprises: a stack comprising a plurality cells and a plurality of cooling plates each provided with a heat medium passage in which a heat medium for cooling the cell flows, each of the plurality of cells including: a membrane and electrode assembly provided with an electrolyte, an anode provided at one face of the electrolyte, and a cathode provided at the other face of the electrolyte; an anode plate provided with a fuel passage facing the anode; and a cathode plate provided with an oxidant passage facing the cathode, and an end plate provided at an end of the stack via a current collector plate and an insulating plate, so as to clamp the stack; and a stack end passage which is provided only in an area of the end plate defined as a first area corresponding to a high-temperature area of the cell in contrast with a second area corresponding to a low-temperature area of the cell, and through each of which the heat medium past the cooling plate flows.

The fuel cell stack according to another aspect of the present invention comprises: a stack comprising a plurality cells and a plurality of cooling plates each provided with a heat medium passage in which a heat medium for cooling the cell flows, each of the plurality of cells including: a membrane and electrode assembly provided with an electrolyte, an anode provided at one face of the electrolyte, and a cathode provided at the other face of the electrolyte; an anode plate provided with a fuel passage facing the anode; and a cathode plate provided with an oxidant passage facing the cathode, and an end plate provided at an end of the stack via a current collector plate and an insulating plate, so as to clamp the stack; and a stack end passage which is provided in the end plate and is provided with an inlet through which the heat medium past the cooling plate flows to the end plate, and an outlet through which the heat medium is emitted outside the end plate, the heat medium flowing through the stack end passage, wherein a distance from the inlet to the outlet in the direction of flow of the heat medium flowing in the stack end passage is equal to or greater than ¼ and equal to or smaller than ½ of a distance in the direction of flow of the heat medium in the electrolyte.

According to these aspects of the invention, the high-temperature portion of the cells at the stack ends is appropriately heated in accordance with the temperature distribution of the other cells with the result that the high-temperature portion of the cells at the stack ends approximates that of the other cells. With this, the quantity of condensed water produced in the cells at the stack ends is reduced and blockage of passage for reactant gases inside the cell is prevented. Since condensed water is uniformly dispersed from portion to portion in the cell's, variation in voltages generated in the cells is controlled so that the fuel cell is operated in a stable manner. While water is most suitable as a heat medium, fluids other than water may also be used.

According to a variation of the aforementioned aspects, there is provided a first flow rate control element that controls the flow rate of the heat medium flowing into the stack end passage in accordance with the temperature of the heat medium. With this, even when an output from the fuel cell stack varies, it is possible to maintain the temperature gradient in the cells at the stack ends constant, by adjusting the temperature of the heat medium flowing in the stack end passage. Accordingly, the stability of operation of the fuel cell stack is improved.

According to another variation of the aforementioned aspects, there is provided a second flow rate control element for controlling the flow rate of the heat medium which flows into a cooling water emission manifold that establishes a passageway through the stack and communicates with the stack end passage, and which passes through the cooling plate provided at the end of the stack, in accordance with the temperature of the heat medium past the cooling plate. With this, even when an output from the fuel cell stack varies, it is possible to maintain the temperature gradient of the cells at the stack ends constant, by adjusting the temperature of the heat medium that passes through the cooling plate at the end of the stack.

According to still another variation of the aforementioned aspects, the heat transfer in the direction of flow of the heat medium flowing in the heat medium passage at portions of the end plates not provided with the stack end passage or at the second area corresponding to the low-temperature area of the cell, is lower than the heat transfer in a direction perpendicular to the direction of flow of the heat medium flowing in the heat medium passage. With this, it is ensured that the high-temperature area of the cell at the end of the stack is heated by the heat medium flowing in the stack end passage, and a temperature distribution that matches the temperature distribution in the cell is applied to the portions of the end plate not provided with the stack end passage. Accordingly, the temperature distribution in the cells at the ends of the stack can approximate the temperature distribution in the other cells. The phrase “direction of flow of the heat medium” does not refer to the direction itself of the heat medium passage provided in the cooling plate but a direction from an inlet of the heat medium passage toward an outlet thereof.

According to still another variation of the aforementioned aspects, each of the fuel passage, the oxidant passage and the heat medium passage comprises a plurality of straight passages such that the fuel flows downward in the fuel passages parallel with the oxidant flowing in the oxidant passages, and the heat medium flows in the heat medium passages parallel with or counter to the fuel and the oxidant. When the fuel passage, the oxidant passage and the heat medium passage meander, non-uniform temperature distribution results at selected areas. With the aforementioned structure, however, contiguous temperature distribution is formed along the passages so that the stability of the fuel cell stack is improved.

According to yet another variation of the aforementioned aspects, the heat transfer in at least one stack end member selected from a group of the current collector plate, the insulating plate and the end plate, in the direction of flow of the heat medium flowing in the heat medium passage, is lower than the heat transfer in a direction perpendicular to the direction of flow of the heat medium.

With this, there is a drop in the heat transfer rate in at least one stack end member selected from a group of the current collector plate, the insulating plate and the end plate, in the direction of flow of the heat medium flowing in the heat medium passage. Consequently, a temperature distribution that matches the temperature distribution in the cells is maintained in the stack end member. Accordingly, the temperature distribution in the cells at the ends of the stack can approximate the temperature distribution of the other cells. With this, the quantity of condensed water produced in the cells at the stack ends of the stack is reduced and blockage of passage for reactant gases inside the cell is prevented. Since condensed water is uniformly dispersed from portion to portion in the cells, variation in voltages generated in the cells is controlled so that the fuel cell is operated in a stable manner.

According to still another variation of the aforementioned aspects, there is provided a plurality of notches in at least one stack end member selected from a group of the current collector plate, the insulating plate and the end plate, in a direction perpendicular to the direction of flow of the heat medium flowing in the heat medium passage.

With this, heat transfer in at least one stack end member selected from a group of the current collector plate, the insulating plate and the end plate, in the direction of flow of the heat medium flowing in the heat medium passage, is blocked by the notches provided in the stack end member. Accordingly, the temperature distribution in the cells at the ends of the stack that matches the temperature distribution in the other cells is maintained. It is thus ensured that the temperature distribution in the cells at the stack ends approximates that of the other cells. With this, the quantity of condensed water produced in the cells at the stack ends of the stack is reduced and blockage of passage for reactant gases inside the cell is prevented. Since condensed water is uniformly dispersed from portion to portion in the cells, variation in voltages generated in the cells is controlled so that the fuel cell is operated in a stable manner.

According to yet another variation of the aforementioned aspects, there are provided a plurality of holes in at least one stack end member selected from a group of the current collector plate, the insulating plate and the end plate, along the flow of the heat medium flowing in the heat medium passage.

With this, heat transfer in at least one stack end member selected from a group of the current collector plate, the insulating plate and the end plate, in the direction of flow of the heat medium flowing in the heat medium passage, is blocked by the holes provided in the stack end member. Accordingly, the temperature distribution in the cells at the ends of the stack that matches the temperature distribution in the other cells is maintained. It is thus ensured that the temperature distribution in the cells at the stack ends approximates that of the other cells. With this, the quantity of condensed water produced in the cells at the stack ends of the stack is reduced and blockage of passage for reactant gases inside the cell is prevented. Since condensed water is uniformly dispersed from portion to portion in the cells, variation in voltages generated in the cells is controlled so that the fuel cell is operated in a stable manner.

According to still another variation of the aforementioned aspects, at least one stack end member selected from a group of the current collector plate, the insulating plate and the end plate, is divided into a plurality of pieces along the flow of the heat medium flowing in the heat medium passage.

With this, heat transfer in at least one stack end member selected from a group of the current collector plate, the insulating plate and the end plate, in the direction of flow of the heat medium flowing in the heat medium passage, is blocked by the stack end member divided by the pieces. Accordingly, the temperature distribution in the cells at the ends of the stack that matches the temperature distribution in the other cells is maintained. It is thus ensured that the temperature distribution in the cells at the stack ends approximates that of the other cells. With this, the quantity of condensed water produced in the cells of the stack is reduced and blockage of passage for reactant gases inside the cell is prevented. Since condensed water is uniformly dispersed from portion to portion in the cells, variation in voltages generated in the cells is controlled so that the fuel cell is operated in a stable manner.

Combinations of any of the above elements are within the scope of the invention sought to be patented in this application.

### BRIEF DESCRIPTION OF THE DRAWINGS

FIG. 1 is a schematic diagram illustrating the structure of a polymer electrolyte fuel cell stack according to example 1.

FIG. 2 is a schematic diagram illustrating the structure of an end plate in the polymer electrolyte fuel cell stack.

FIG. 3A illustrates a flow rate control element provided in the end plate.

FIG. 3B is a section of the flow rate control element illustrated in FIG. 3A along the line B-B.

FIG. 4 is a schematic diagram illustrating a polymer electrolyte fuel cell stack according to comparative example 1.

FIG. 5 illustrates the structure of an end plate of the polymer electrolyte fuel cell stack according to comparative example 1.

FIG. 6 is a schematic diagram illustrating a polymer electrolyte fuel cell stack according to comparative example 2.

FIG. 7 is a graphical presentation of experimental results from measurement of temperature distribution in the cells of the polymer electrolyte fuel cell stack according to comparative examples 1 and 2.

FIG. 8 is a schematic diagram illustrating the structure of an end plate of a polymer electrolyte fuel cell stack according to example 2.

FIG. 9 is a schematic diagram illustrating the structure of an end plate of a polymer electrolyte fuel cell stack according to example 3.

FIG. 10 is a schematic diagram illustrating the structure of a polymer electrolyte fuel cell stack according to example 4.

FIG. 11 is a schematic diagram illustrating the structure of an end plate of the polymer electrolyte fuel cell stack according to example 4.

FIG. 12 is a schematic diagram illustrating the structure of an end plate of a polymer electrolyte fuel cell stack according to example 5.

FIG. 13 is a schematic diagram illustrating the structure of an end plate of a polymer electrolyte fuel cell stack according to example 6.

FIG. 14 is a schematic diagram illustrating the structure of an end plate of a polymer electrolyte fuel cell stack according to example 7.

### DETAILED DESCRIPTION OF THE INVENTION

### EXAMPLE 1

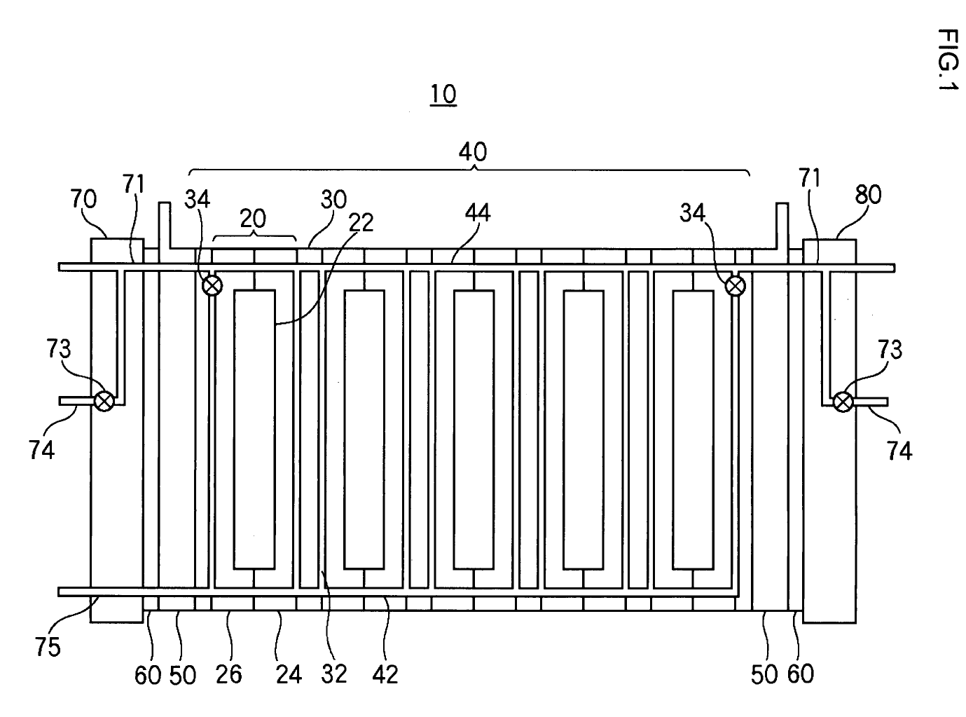

FIG. 1 is a schematic diagram illustrating the structure of a polymer electrolyte fuel cell stack according to example 1.

The polymer electrolyte fuel cell stack 10 comprises: a stack 40 in which a plurality of cells 20 and a plurality of cooling plates 30 sandwiched between the cells 20 are stacked; and end plates 70, 80 clamping the stack 40 at both ends of the stack 40 via current collector plates 50 and insulating plates 60.

The cell 20 is provided with an MEA 22, an anode plate 24 provided with a fuel passage facing an anode of the MEA 22, and a cathode plate 26 provided with an oxidant passage facing a cathode of the MEA 22. The cooling plate 30 is provided with a cooling water passage 32 in which cooling water used as a heat medium flows. In the vicinity of an outlet of the cooling water passage 32 of the cooling plates 30 located at respective ends of the stack is provided a flow rate control element 34 for controlling the flow rate of cooling water flowing from the cooling water passage 32 to a cooling water emission manifold 44 described later.

The flow rate control element 34 will be described later. The cooling water passage 32 may be provided at the side of the anode plate 24 and/or the cathode plate 26 opposite to the side facing the MEA 22. In this case, the anode plate 24 and/or the cathode plate 26 also serve as the cooling plates 30. The use, in part, of bipolar plates, each of which is provided with a fuel passage on one face and an oxidant passage on the other, is also within the scope of the present invention.

Underneath the stack 40 is provided with a cooling water supply manifold 42 that establishes a passageway through the cells 20 in the direction of stack. On top of the stack 40 is provided a cooling water emission manifold 44 that establishes a passageway through the cells 20 in the direction of stack.

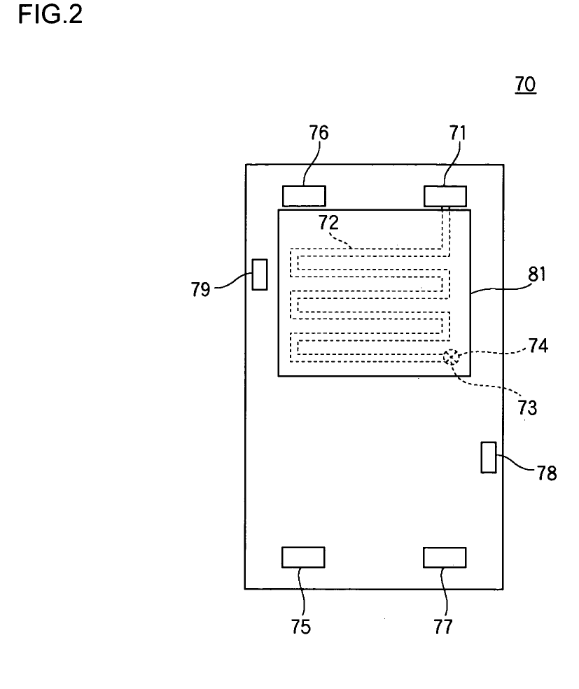

FIG. 2 is a schematic diagram illustrating the structure of the end plate 70. The end plate 70 is provided with a cooling water supply inlet 71, a stack end passage 72, a flow rate control element 73, a cooling water emission outlet 74, a cooling water inlet 75, a fuel inlet 76, a fuel outlet 77, an oxidant inlet 78 and an oxidant outlet 79.

The cooling water supply inlet 71 communicates with the cooling water emission manifold 44 so that cooling water having its temperature raised to a level close to the operating temperature flows from the cooling water emission manifold 44 to the stack end passage 72 via the cooling water supply inlet 71. In other words, the cooling water supply inlet 71 is an inlet of cooling water past the cooling plate 30 and flowing to the end plate 70. The stack end passage 72 is formed as a tunnel, by attaching a block plate 81 on a trench configuration provided in the end plate 70. Preferably, the block plate 81 is formed of a material of excellent heat transfer. The stack end passage 72 is formed as a practically sigmoidal contiguous route in the upper area of the end plate 70 corresponding to a high-temperature area of the cell 20.

More specifically, the stack end passage 72 is provided only in an area of the end plate 70 defined as a first area corresponding to the high-temperature area of the cell 20 in contrast with a second area corresponding to a low-temperature area. Alternatively, a significantly small stack end passage may be provided in the second area than in the first area, when the structure of the polymer electrolyte fuel cell stack 10 demands.

The flow rate control element 73 is provided in the vicinity of the cooling water emission outlet 74 of the stack end passage 72 so as to maintain the water temperature of cooling water in the stack end passage 72 at a predetermined level by adjusting the flow rate of cooling water flowing into the stack end passage 72. For example, the flow rate control element 73 is formed of a temperature-sensitive flow rate control element deformed in accordance with the temperature of cooling water flowing in the stack end passage 72 and having completed heat exchange. The flow rate control element 73 has the function of valve that opens and closes in accordance with the temperature of cooling water in the stack end passage 72. To give specific examples, a bimetal, a memory metal or a thermoloid may be used as the temperature-sensitive flow rate control element. Instead of using the temperature-sensitive flow rate control element, there may be provided a temperature sensor detecting the temperature of cooling water, the temperature of the end plate 70 and the temperature of the cells 20 at the stack ends, and a regulatable valve, so that the valve is regulated for its position in accordance with the water temperature of cooling water in the stack end passage 72 detected by the temperature sensor. In this case, the position of the valve may be in the vicinity of the stack end passage 72.

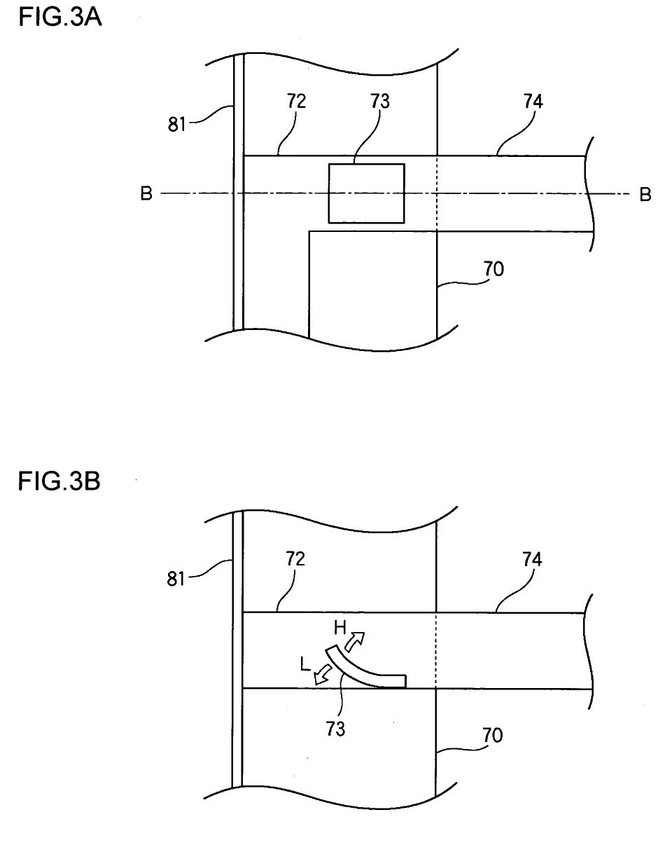

FIG. 3A illustrates the structure in which the flow rate control element 73. FIG. 3B is a section along the line B-B of FIG. 3A. The flow rate control element 73 detects the temperature of the cooling water flowing the stack end passage 72 and having completed heat exchange, and adjust the flow rate of cooling water flowing in the stack end passage 72 accordingly. More specifically, the flow rate control element 73 is in a normal state that allows a predetermined flow rate when the temperature of cooling water is at a predetermined level. When the temperature of cooling water is equal to or higher than the predetermined level, the flow rate control element 73 is deformed from the normal state in a direction indicated by arrow H of FIG. 3B, thereby reducing the sectional area of the stack end passage 72 and reducing the flow rate of cooling water flowing in the stack end passage 72 accordingly. When the temperature of cooling water is equal to or below the predetermined level, the flow rate control element 73 is deformed from the normal state in a direction indicated by arrow L of FIG. 3B, thereby increasing the sectional area of the stack end passage 72 and increasing the flow rate of cooling water in the stack end passage 72.

With this, the temperature distribution in the cells 20 at the respective stack ends is maintained constant and the operation of the polymer electrolyte fuel cell stack 10 is stabilized, by maintaining the temperature of cooling water in the stack end passage 72 constant when an output from the polymer electrolyte fuel cell stack 10 varies and the temperature of the cells 20 varies accordingly.

The cooling water emission outlet 74 communicates with an outlet of the stack end passage 72 and emits cooling water that has flown in the stack end passage 72. The cooling water inlet 75 communicates with the cooling water supply manifold 42. The cooling water emission outlet 74 is an outlet for emitting cooling water outside the end plate 70. A description of the fuel inlet 76, the fuel outlet 77, the oxidant inlet 78 and the oxidant outlet 79 will be given later.

The cooling water supply inlet 71 also communicates with a space outside the polymer electrolyte fuel cell stack 10 and is capable of emitting extra cooling water not flowing into the stack end passage 72.

The basic structure of the end plate 80 is the same as that of the end plate 70. However, the cooling water inlet 75, the fuel inlet 76, the fuel outlet 77, the oxidant inlet 78 and the oxidant outlet 79 are not provided.

Preferably, the distance from the cooling water supply inlet 71 to the cooling water emission outlet 74 in the direction of flow of cooling water is equal to or greater than ¼ and equal to or smaller than ½ and more preferably equal to or greater than ⅓ and equal to or smaller than ½, of the extent of the MEA 22 in the direction of flow of cooling water.

(Flow of Reactant Gas)

The fuel gas such as a reformed gas is supplied from the fuel inlet 76 and distributed to the cells 20 via a fuel supply manifold (not shown) provided to establish a passageway through the polymer electrolyte fuel cell stack 10 in the direction of stack. The fuel gas supplied to the cells 20 flows through the fuel passage. The oxidant gas such as air is supplied from the oxidant inlet 78 and distributed to the cells 20 via an oxidant gas supply manifold (not shown) provided to establish a passageway through the polymer electrolyte fuel cell stack 10 in the direction of stack. The oxidant gas supplied to the cells 20 flows through the oxidant passage.

The cells 20 in which the fuel gas and the oxidant gas flow generate power as a result of electrochemical reaction mediated by the electrolyte membrane. The unreacted fuel gas emitted from the cells 20 comes into confluence at a fuel emission manifold (not shown) provided to establish a passageway through the polymer electrolyte fuel cell stack 10 in the direction of stack, and is emitted outside via the fuel emission manifold and the fuel emission outlet 77. The unreacted fuel gas emitted from the fuel outlet 77 is generally burned by being introduced into a reformer burner of a fuel reformer apparatus (not shown).

The unreacted oxidant gas emitted from the cells 20 subsequent to a power generation reaction comes into confluence at an oxidant emission manifold (not shown) provided to establish a passageway through the polymer electrolyte fuel cell stack 10 in the direction of stack, and is emitted outside via the oxidant emission manifold and the oxidant outlet 79.

(Flow of Cooling Water)

Cooling water is supplied from the cooling water inlet 75 and distributed to the cooling water passage 32 via the cooling water manifold 42 provided to establish a passageway through the polymer electrolyte fuel cell stack 10 in the direction of stack. Cooling water that flows through the cooling water passage 32 maintains the cells 20 at a proper operating temperature (for example, approximately 70-80° C.) by cooling the cells 20.

The temperature of cooling water emitted from the cooling water passage 32 is raised by heat of reaction generated in the cells 20 to approximately 72-75° C. Cooling water having its temperature raised flows into the cooling water emission manifold 44. A partition (not shown) may be provided in the vicinity of the middle of the cooling water emission manifold 44 in the direction of the polymer electrolyte fuel cell stack 10, so that cooling water, having its temperature raised, is diverged by the partition in two directions.

The basic structure of the flow rate control element 34 provided in the vicinity of the outlet of the cooling water passage 32 at the respective stack ends is the same as that of the flow rate control element 73 provided in the end plate 70. A difference is as follows. The flow rate control element 34 is in a normal state that allows a predetermined flow rate when the temperature of cooling water that has flown in the cooling water passage 32 at the stack end is at a predetermined level. When the temperature of cooling water that has flown in the cooling water passage 32 is equal to or higher than the predetermined level, the flow rate control element 34 enlarges the sectional area of the cooling water passage 32 at the stack end and increases the flow rate of cooling water flowing in the cooling water passage 32 at the stack end. When the temperature of cooling water is equal to or below the predetermined level, the flow rate control element 34 increases the sectional area of the cooling water passage 32 at the stack end and reduces the flow rate of cooling water flowing in the cooling water passage 32 at the stack end.

With this, the temperature distribution of the cells 20 at the respective stack ends is maintained constant and the operation of the polymer electrolyte fuel cell stack 10 is stabilized, by maintaining the temperature of cooling water in the cooling water passage 32 at the stack end constant when an output from the polymer electrolyte fuel cell stack 10 varies and the temperature of the cells 20 varies accordingly.

Cooling water flowing in the cooling water emission manifold 44 to the end plate 70 flows into the stack end passage 72 via the cooling water supply inlet 71 of the end plate 70 and flows downward from the upper part of the end plate 70 in the form of meander. The flow, in the stack end passage 72, of cooling water having its temperature raised heats the cell 20 at the stack end adjacent to the end plate 70 via the block plate 81, the current collector plate 50 and the insulating plate 60. Further, the stack end passage 72 is provided at the upper area of the end plate 70 corresponding to the high-temperature area of the cell 20. Therefore, the temperature of cooling water flowing in the stack end passage 72 gradually drops toward the downstream in the stack end passage 72. With this, it is ensured that the high-temperature area of the cell 20 facing the end plate 70 is efficiently heated and the temperature distribution of the cell 20 facing the end plate 70 approximates that of the other cells 20.

Cooling water flowing in the cooling water emission manifold 44 to the end plate 80 flows into the stack end passage 72 via the cooling water supply inlet 71 of the end plate 80 and flows downward from the upper part of the end plate 80 in the form of meander. The flow, in the stack end passages 72, of cooling water having its temperature raised heats the cells 20 at the stack end adjacent to the end plate 80 via the block plate 81, the current collector plate 50 and the insulating plate 60. Further, the stack end passage 72 is provided in the upper area of the end plate 80 corresponding to the high-temperature area of the cell 20. Therefore, the temperature of cooling water flowing in the stack end passage 72 gradually drops toward the downstream in the stack end passage 72. With this, it is ensured that the high-temperature area of the cell 20 facing the end plate 80 is efficiently heated and the temperature distribution of the cell 20 facing the end plate 80 approximates that of the other cells 20.

As a result of the high-temperature area of the cell 20 at the stack ends being heated, the quantity of condensed water produced in the cells 20 at the stack ends is reduced and the temperature distribution in the cells 20 at the respective stack ends approximates that of the other cells 20. Consequently, condensed water is produced at mutually corresponding areas in the cells 20 so that power generation efficiency in the cells 20 can be improved uniformly.

From the perspective of optimization of the temperature distribution in the cells 20 while the polymer electrolyte fuel cell stack 10 is being operated, it is preferable that each of the fuel passage, the oxidant passage and the cooling water passage 32 comprises a plurality of straight passages such that the fuel flows downward in the fuel passages parallel with the oxidant flowing in the oxidant passages, and the cooling water flows in the cooling water passage 32 parallel with or counter to the fuel and the oxidant. It is more preferable that cooling water flowing in the cooling water passage 32 flows counter to the fuel gas and the oxidant gas, i. e. cooling water flow upward. With this, contiguous temperature distribution is created along the passages so that the stability of the polymer electrolyte fuel cell stack 10 is improved.

### COMPARATIVE EXAMPLE 1

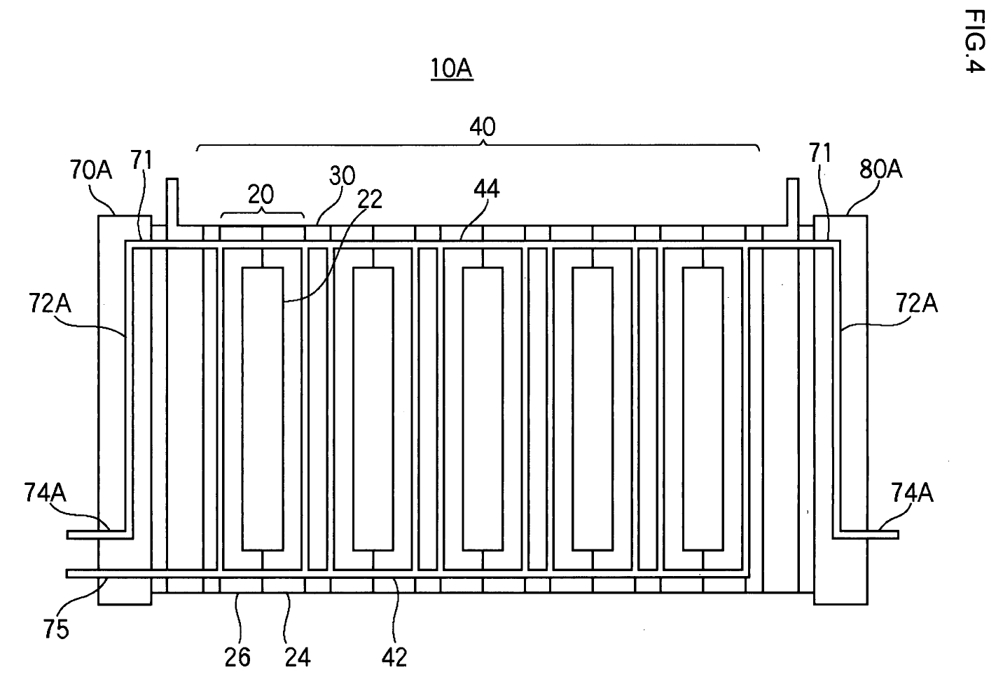

FIG. 4 illustrates a polymer electrolyte fuel cell stack 10A according to comparative example 1 given for comparison with example 1 above. The basic structure of the polymer electrolyte fuel cell stack 10A is the same as that of the polymer electrolyte fuel cell stack 10 according to example 1. Therefore, like numerals represent like members and a detailed description thereof is omitted. The flow rate control element 34 is not provided in the cooling water passage 32 at the stack end of the polymer electrolyte fuel cell stack 10A. Further, the configuration of the water passage provided in end plates 70A, 80A differs from that of example 1.

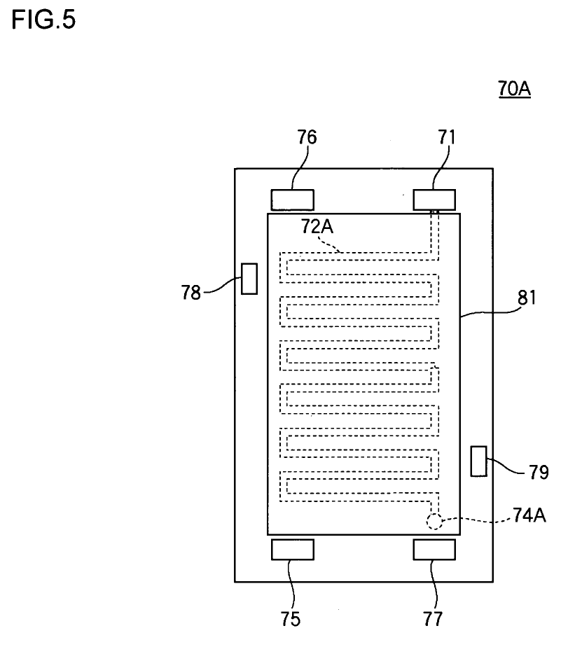

A description will be given only of the end plate 70A, since the end plate 70A and the end plate 80A has practically the same structure. Comparative example 1 differs from example 1 in that, as illustrated in FIG. 5, a stack end passage 72A is formed as a practically sigmoidal contiguous route on the entirety of the end plate 70A, and the flow rate control element 73 is not provided so that the entirety of cooling water supplied from the cooling water supply inlet 71 flows into the stack end passage 72. In the end plate 70A of comparative example 1, the oxidant inlet 78 and the oxidant outlet 79 change their places from the example 1.

In comparative example 1, cooling water having its temperature raised and emitted from the cells 20 subsequent to a power generation reaction flows into the stack end passage 72A via the cooling water emission manifold 44A. Cooling water then flows downward in the form of meander and emitted outside via a cooling water emission outlet 74A provided at the lower end.

In comparative example 1, the stack end passage 72A is provided on practically the entirety of the end plate 70A. Further, the entirety of cooling water supplied from the cooling water supply inlet 71 flows into the stack end passage 72A without limitation. Accordingly, the end plate 70A is maintained at a uniform temperature without creating any specific pattern of temperature distribution. When an output of the polymer electrolyte fuel cell stack varies, the temperature of the end plate 70A also varies.

### COMPARATIVE EXAMPLE 2

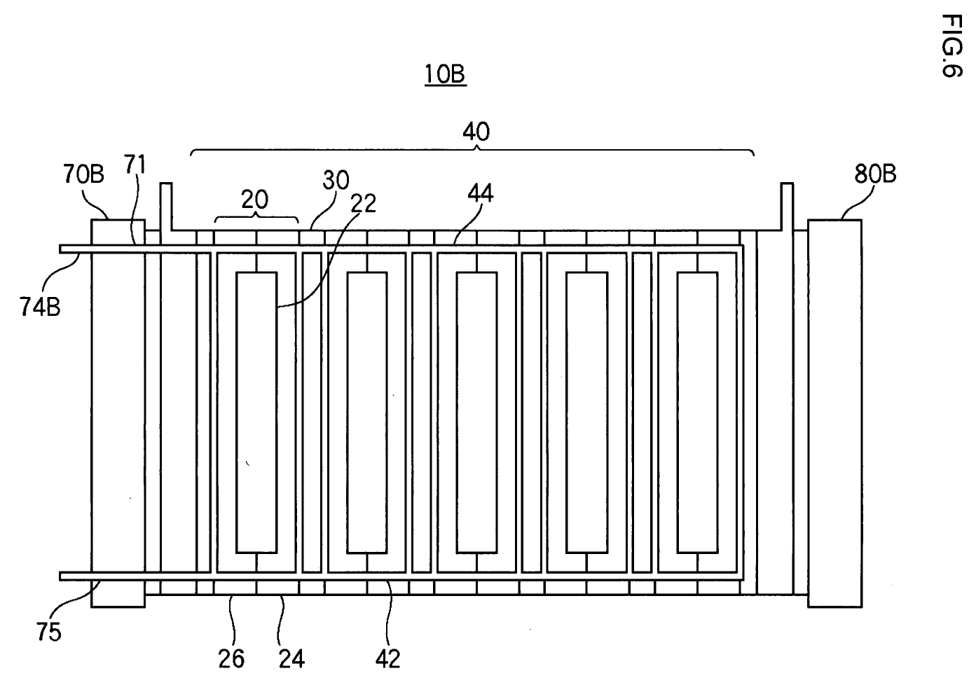

FIG. 6 illustrates a polymer electrolyte fuel cell stack 10B according to comparative example 2 given for comparison with example 1 above. The basic structure of the polymer electrolyte fuel cell stack 10B is the same as that of the polymer electrolyte fuel cell stack 10 according to example 1. Therefore, like numerals represent like members and a detailed description thereof is omitted. The polymer electrolyte fuel cell stack 10B significantly differs from the polymer electrolyte fuel cell stack 10 of example 1 in that end plates 70B and 80B are not provided with a water passage. The end plate 70B, however, is provided with a cooling water emission outlet 74B communicating with the cooling water emission manifold 44.

In comparative example 2, cooling water having its temperature raised and emitted from the cells 20 subsequent to a power generation reaction is emitted outside the cell from the cooling water emission outlet 74B of the end plate 70B via the cooling water emission manifold 44. Accordingly, heating of the cells 20 at the respective stack ends using heated cooling water is not performed.

(Evaluation of Example and Comparative Examples)

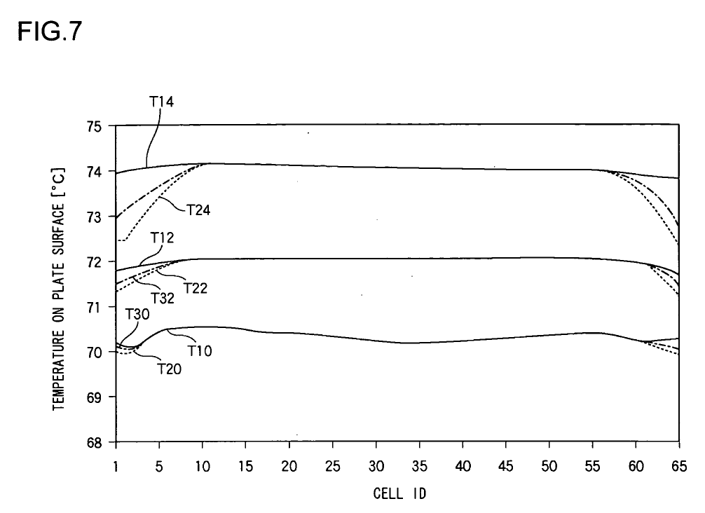

Three polymer electrolyte fuel cell stacks according to example 1, comparative example 1 and comparative example 2, in which a total number of cells is 65, are fabricated. The temperature distribution in the cells during a power generation reaction is measured. FIG. 7 presents experimental results from measurement of temperature distribution in the cells. The temperature of the cells is measured at the lower end part of the cell, the central part of the cell and the upper end part of the cell. FIG. 7 reveals that there is little difference between the cells at the stack ends and the other cells, in terms of temperature T10 at the cell lower end, temperature T12 at the cell central part and temperature T14 at the cell upper end, verifying that the there is a close approximation in temperature distribution in the cells.

In contrast, temperature T20 at the cell lower end, temperature T22 at the cell central part and temperature T24 at the cell upper end of the cells at the stack ends according to comparative example 2 are lower than the corresponding temperature levels in the other cells. The most significant drop in temperature in the cells at the stack ends is found in temperature T24 at the cell upper end.

Temperature T30 at the cell lower end, temperature T32 at the cell central part and temperature T34 at the cell upper end of the cells at the stack ends according to comparative example 1 are improved in comparison with comparative example 2. There still remains, however, a difference in temperature distribution in the cells at the stack ends and in the other cells.

The above experimental results show that successful approximation in temperature distribution in the cells is achieved in the polymer electrolyte fuel cell stack according to example 1, by causing cooling water, having its temperature raised with temperature control, to flow in portions of the end plate 70 and the end plate 80 corresponding to the high-temperature area of the cells.

The route of the stack end passage 72 in the end plates 70, 80 of the polymer electrolyte fuel cell stack is not restricted to the form of example 1. In example 2 and example 3 described below, the basic structure remains unchanged from example 1 except for a difference in respect of the structure of the stack end passage 72 of the end plates 70 and 80. Therefore, like numerals represent like members and a description thereof is omitted.

### EXAMPLE 2

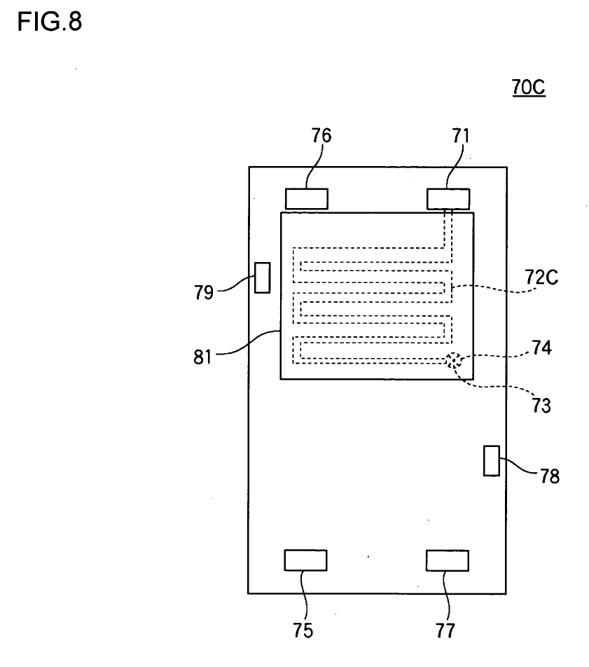

FIG. 8 is a schematic diagram illustrating the structure of an end plate of a polymer electrolyte fuel cell stack according to example 2. A stack end passage 72C of an end plate 70C according to example 2 shares common features with the passage of example 1 in that the passage is formed as a practically sigmoidal route at the upper area of the end plate 70C corresponding to the high-temperature area of the cells 20. A difference is that the stack end passage 72C according to example 2 has a larger sectional area toward the top of the end plate 70C. With this, the top part of the cells 20 at the stack ends are effectively heated by cooling water flowing the stack end passage 72C. Accordingly, it is ensured that the temperature of the cells 20 at the stack ends approximates that of the other cells 20.

### EXAMPLE 3

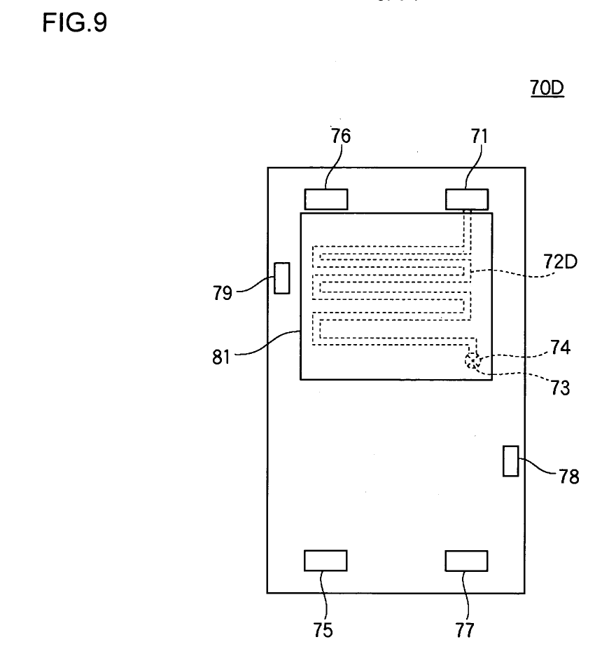

FIG. 9 is a schematic diagram illustrating the structure of an end plate 70D of a polymer electrolyte fuel cell stack according to example 3. A stack end passage 72D of the end plate 70D according to example 3 shares common features with the passage of example 1 in that the passage is formed as a practically sigmoidal route at the upper area of the end plate 70D corresponding to the high-temperature area of the cells 20. A difference is that intervals between loop back segments of the route of the stack end passage 72D according to example 3 are smaller toward the upper part of the end plate 70D. With this, the upper part of the cells 20 at the stack ends are effectively heated by cooling water flowing in the stack end passage 72D so that it is ensured that the temperature distribution of the cells 20 at the stack ends approximates that of the other cells 20.

While the stack end passages in examples 1-3 are formed at the end plates 70 and 80, they may be formed in the current collector plate 50 or the insulating plate 60 instead of the end plates 70 and 80. Further, the end plates 70 and 80 may serve the function of the insulating plate 60. For example, a stack end passage may be formed by forming a trench in the end plates 70 and 80, and the insulating plate 60 and bonding each of the end plate 70 and 80 with the insulating plate 60.

Examples 1-3 described above are modes of applying an appropriate temperature distribution to the cells at the stack ends using cooling water having its temperature raised by the heat of reaction in the cells. A description will now be given of establishing an appropriate temperature distribution in the cells at the stack ends according to a mode different from that of examples 1-3.

### EXAMPLE 4

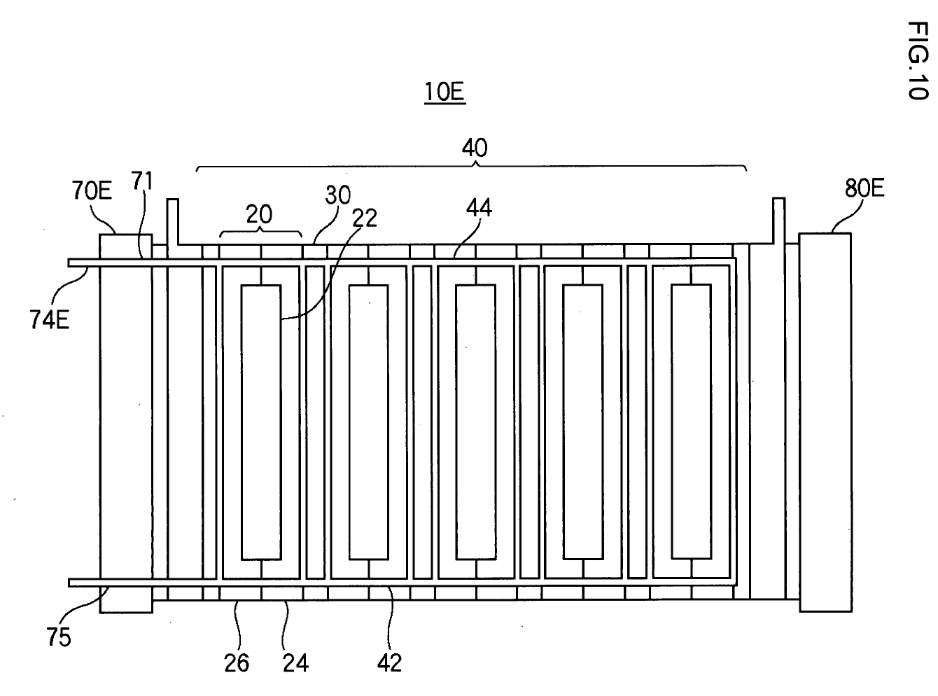

FIG. 10 illustrates the structure of a polymer electrolyte fuel cell stack 10E according to example 4. The basic structure of the polymer electrolyte fuel cell stack 10E is the same as that of the polymer electrolyte fuel cell stack 10 according to example 1. Therefore, like numerals represent like members and a detailed description thereof is omitted. A description will be given only of an end plate 70E, since the end plate 70E and an end plate 80E has practically the same structure. A difference is that the end plate 70E of the polymer electrolyte fuel cell stack 10E is provided with a cooling water emission outlet 74E communicating with the cooling water emission manifold 44.

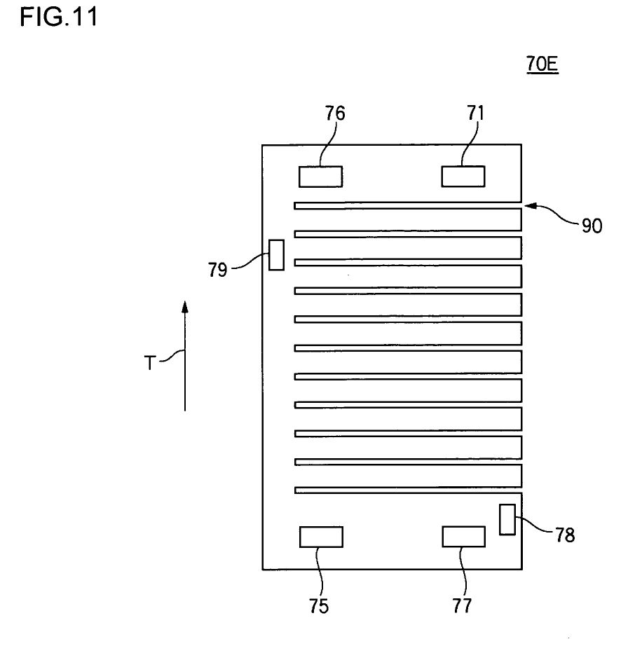

FIG. 11 is a schematic diagram illustrating the structure of the end plate 10E of the polymer electrolyte fuel cell stack according to example 4. A plurality of notches 90 are provided in the end plate 70E in a direction perpendicular to the direction of flow of cooling water in the cells 20 indicated by arrow T.

The notches 90 block heat transfer in a direction indicated by arrow T in the end plate 70E, thereby causing the heat transfer rate in the direction of flow of cooling water in the cells 20 is lower than the heat transfer rate in the direction perpendicular to the flow of cooling water in the cells 20. As a result of this, a temperature difference between the upper part of the end plate 70E and the lower part thereof is maintained. A drop in temperature in the upper part of the cell 20 adjacent to the end plate 70E occurring via the current collector plate 50 and the insulating plate 60 is controlled so that it is ensured that the temperature distribution in the cells 20 at the stack ends approximates that of the other cells 20.

While the plurality of notches 90 in example 4 are provided from one lateral edge of the end plate 70E, the plurality of notches 90 may be provided by alternately cutting from both lateral edges of the end plate 70E.

Other modes are possible for establishing a difference between the direction of flow of cooling water and the direction perpendicular thereto, in respect of the heat transfer rate in the end plate 70E of the polymer electrolyte fuel cell stack. In example 5 and example 6 described below, the basic structure remains unchanged from that of example 4 except for a difference in the structure from the end plates 70E and 80E. Therefore, like numerals represent like members and a detailed description thereof is omitted.

### EXAMPLE 5

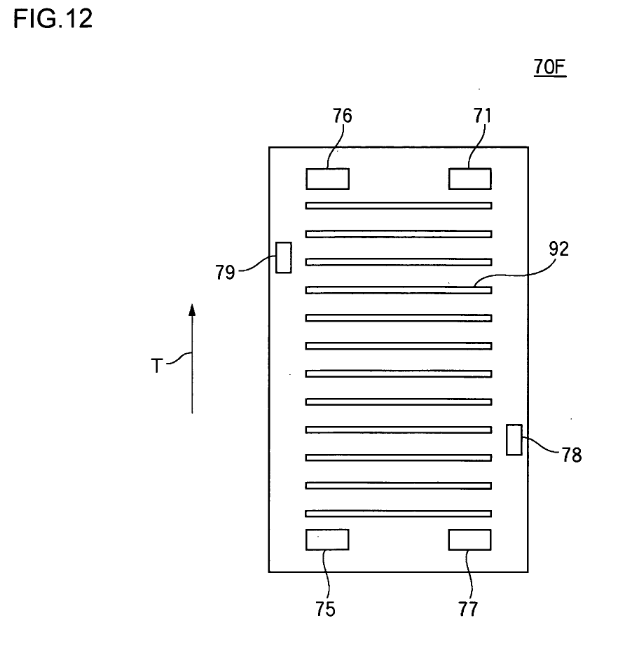

FIG. 12 is a schematic diagram illustrating the structure of an end plate 70F of a polymer electrolyte fuel cell stack according to example 5. A plurality of holes 92 are provided in the end plate 70F along the flow of cooling water in the cooling water passage 32 indicated by arrow T. Preferably, the holes 92 are configured such that the length thereof lies perpendicular to the direction of flow of cooling water.

The hole 92 blocks heat transfer in the direction in the end plate 70F indicated by arrow T, thereby causing the heat transfer rate in the direction of flow of reactant gas in the cells 20 is lower than the heat transfer rate in the direction perpendicular to the flow of cooling water in the cooling water passage 32. As a result of this, a temperature difference between the upper part of the end plate 70E and the lower part thereof is maintained. A drop in temperature in the upper part of the cell 20 adjacent to the end plate 70F occurring via the current collector plate 50 and the insulating plate 60 is controlled so that it is ensured that the temperature distribution in the cells 20 at the stack ends approximates that of the other cells 20.

### EXAMPLE 6

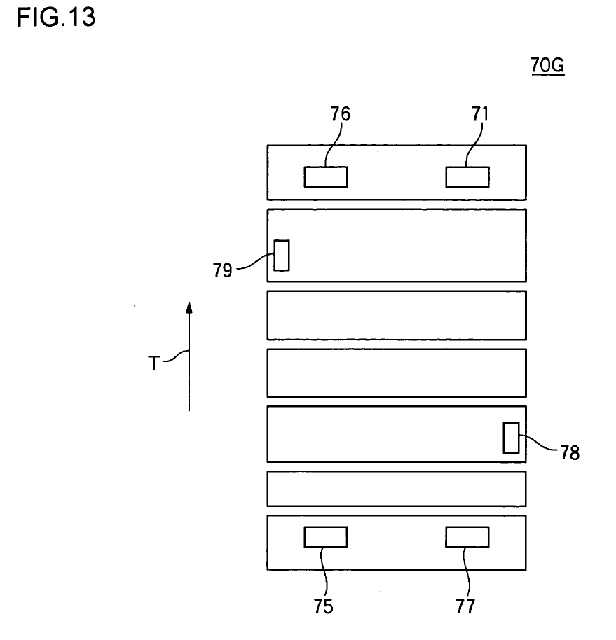

FIG. 13 illustrates the structure of an end plate 70G of a polymer electrolyte fuel cell stack according to example 6. The end plate 70G is divided into a plurality of pieces along the flow of cooling water in the cooling passage 32 indicated by arrow T. As a result of the end plate 70G being divided into a plurality of pieces, heat transfer between the pieces of the end plate 70G is significantly blocked. Accordingly, the heat transfer rate in the direction of flow of cooling water in the cooling water passage 32 is lower than the heat transfer rate in the direction perpendicular to the flow of cooling water in the cooling water passage 32. As a result of this, a temperature difference between the upper part of the end plate 70G and the lower part thereof is maintained. A drop in temperature in the upper part of the cell 20 adjacent to the end plate 70G occurring via the current collector plate 50 and the insulating plate 60 is controlled so that it is ensured that the temperature distribution in the cells 20 at the stack ends approximates that of the other cells 20. When the end plate 70G is divided into a plurality of pieces, the polymer electrolyte fuel cell stack is clamped by each of the individual pieces of the end plate 70G, using a rod or the like.

The configuration of the end plates described in examples 4-6 is also applicable to the current collector 50 or the insulating plate 60 as well as to the end plates 70 and 80. Further, the described configuration is also applicable to a structure in which the end plates 70 and 80 also serve as the insulating plate 60. In any of the alternative structures above, heat transfer, in the direction of flow of cooling water in the cooling water passage 32 in the current collector plate 50 or the insulating plate 60, is blocked, thereby causing the heat transfer rate in the direction of flow of cooling water in the cooling water passage 32 in the current collector plate 50 or the insulating plate 60 is lower than the heat transfer rate in the direction perpendicular to the flow of cooling water in the cooling water passage 32. As a result of this, a temperature difference between the upper part of the current collector plate 50 or the insulating plate 60 and the lower part thereof is maintained. A drop in temperature in the upper part of the cells 20 at the stack ends is controlled so that it is ensured that the temperature distribution in the cells 20 at the stack ends approximates that of the other cells 20.

The present invention is not limited to the aforementioned modes of practicing. Various variations in design or the like would occur to a skilled person on the basis of the knowledge in the art. Those variations are encompassed in the scope of the present invention. It is also possible to ensure that the temperature distribution in the cells 20 at the stack ends approximates that of the other cells 20, by combining the mode of practicing the invention according to any of examples 1-3 with the mode according to any of examples 4-6.

### EXAMPLE 7

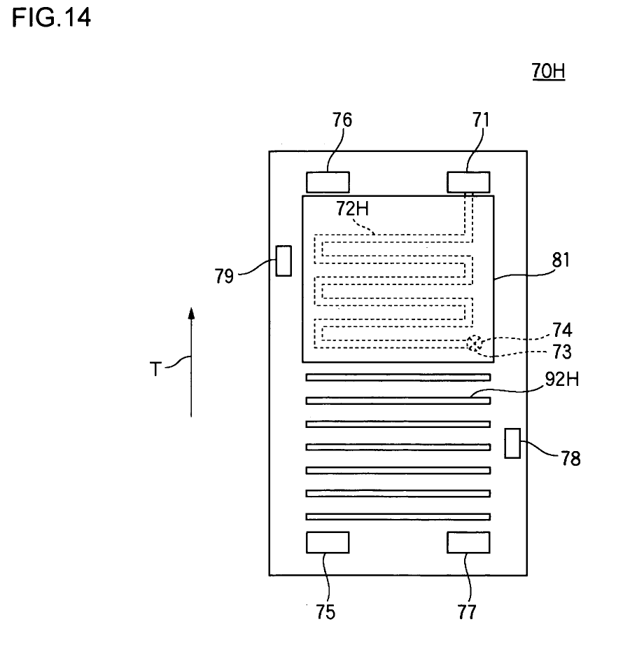

FIG. 14 illustrates the structure of an end plate 70H of a polymer electrolyte fuel cell stack according to example 7. The polymer electrolyte fuel cell stack according to example 7 shares the common basic structure with example 1. In addition to a stack end passage 72H formed as a practically sigmoidal contiguous route in the upper area of the end plate 70H corresponding to the high-temperature area of the cells 20, a plurality of holes 92H are provided in the lower area thereof along the flow of cooling water in the cooling water passage 32 indicated by arrow T.

With this, the upper area of the end plate 70H corresponding to the high-temperature area of the cells 20 is appropriately heated. In addition, a temperature gradient is created the lower area of the end plate 70H such that the temperature is lower toward the downstream of the flow of cooling water in the cells 20. Therefore, it is ensured that the temperature distribution in the cells 20 at the stack ends approximates that of the other cells 20.

The notches 90 according to example 4 or the divided structure according to example 6 may be employed in addition to or in place of the holes 92H according to example 7.

In the above-described examples, the stack end passage is formed as a trench formed in the end plate. Alternatively, the stack end passage may be formed outside the end plate. In this case, it is preferable that the stack end passage be covered by a heat insulating material for protection.

1. A fuel cell stack comprising:
a stack comprising a plurality cells and a plurality of cooling plates each provided with a heat medium passage in which a heat medium for cooling the cell flows, each of the plurality of cells including:
a membrane and electrode assembly provided with an electrolyte, an anode provided at one face of the electrolyte, and a cathode provided at the other face of the electrolyte;
an anode plate provided with a fuel passage facing the anode; and
a cathode plate provided with an oxidant passage facing the cathode, the stack further comprising:
an end plate provided at an end of the stack via a current collector plate and an insulating plate, so as to clamp the stack; and
a stack end passage which is provided in an area of the end plate corresponding to a high-temperature area of the cell, and through each of which the heat medium past the cooling plate flows.

2. The fuel cell stack according to claim 1, further comprising a first flow rate control element that controls the flow rate of the heat medium flowing into the stack end passage in accordance with the temperature of the heat medium.

3. The fuel cell stack according to claim 1, further comprising a second flow rate control element for controlling the flow rate of the heat medium which flows into a cooling water emission manifold that establishes a passageway through the stack and communicates with the stack end passage, and which passes through the cooling plate provided at the end of the stack, in accordance with the temperature of the heat medium past the cooling plate.

4. The fuel cell stack according to claim 2, further comprising a second flow rate control element for controlling the flow rate of the heat medium which flows into a cooling water emission manifold that establishes a passageway through the stack and communicates with the stack end passage, and which passes through the cooling plate provided at the end of the stack, in accordance with the temperature of the heat medium past the cooling plate.

5. The fuel cell stack according to claim 1, wherein the heat transfer in the direction of flow of the heat medium flowing in the heat medium passage at portions of the end plate not provided with the stack end passage, is lower than the heat transfer in a direction perpendicular to the direction of flow of the heat medium flowing in the heat medium passage.

6. The fuel cell stack according to claim 1, wherein each of the fuel passage, the oxidant passage and the heat medium passage comprises a plurality of straight passages such that the fuel flows downward in the fuel passages parallel with the oxidant flowing in the oxidant passages, and the heat medium flows in the heat medium passages parallel with or counter to the fuel and the oxidant.

7. The fuel cell stack according to claim 1, wherein the heat transfer in at least one stack end member selected from a group of the current collector plate, the insulating plate and the end plate, in the direction of flow of the heat medium flowing in the heat medium passage, is lower than the heat transfer in a direction perpendicular to the direction of flow of the heat medium.

8. The fuel cell stack according to claim 7, further comprising a plurality of notches in at least one stack end member selected from a group of the current collector plate, the insulating plate and the end plate, in a direction perpendicular to the direction of flow of the heat medium flowing in the heat medium passage.

9. The fuel cell stack according to claim 7, further comprising a plurality of holes in at least one stack end member selected from a group of the current collector plate, the insulating plate and the end plate, along the flow of the heat medium flowing in the heat medium passage.

10. The fuel cell stack according to claim 7, wherein at least one stack end member selected from a group of the current collector plate, the insulating plate and the end plate, is divided into a plurality of pieces along the flow of the heat medium flowing in the heat medium passage.

11. A fuel cell stack comprising:
a stack comprising a plurality cells and a plurality of cooling plates each provided with a heat medium passage in which a heat medium for cooling the cell flows, each of the plurality of cells including:
a membrane and electrode assembly provided with an electrolyte, an anode provided at one face of the electrolyte, and a cathode provided at the other face of the electrolyte;
an anode plate provided with a fuel passage facing the anode; and
a cathode plate provided with an oxidant passage facing the cathode, the fuel cell stack further comprising:
an end plate provided at an end of the stack via a current collector plate and an insulating plate, so as to clamp the stack; and
a stack end passage which is provided only in an area of the end plate defined as a first area corresponding to a high-temperature area of the cell in contrast with a second area corresponding to a low-temperature area of the cell, and through each of which the heat medium past the cooling plate flows.

12. The fuel cell stack according to claim 11, further comprising a first flow rate control element that controls the flow rate of the heat medium flowing into the stack end passage in accordance with the temperature of the heat medium.

13. The fuel cell stack according to claim 11, further comprising a second flow rate control element for controlling the flow rate of the heat medium which flows into a cooling water emission manifold that establishes a passageway through the stack and communicates with the stack end passage, and which passes through the cooling plate provided at the end of the stack, in accordance with the temperature of the heat medium past the cooling plate.

14. The fuel cell stack according to claim 12, further comprising a second flow rate control element for controlling the flow rate of the heat medium which flows into a cooling water emission manifold that establishes a passageway through the stack and communicates with the stack end passage, and which passes through the cooling plate provided at the end of the stack, in accordance with the temperature of the heat medium past the cooling plate.

15. The fuel cell stack according to claim 11, wherein the heat transfer in the direction of flow of the heat medium flowing in the heat medium passage at the second area of the end plate, is lower than the heat transfer in a direction perpendicular to the direction of flow of the heat medium flowing in the heat medium passage.

16. The fuel cell stack according to claim 11, wherein each of the fuel passage, the oxidant passage and the heat medium passage comprises a plurality of straight passages such that the fuel flows downward in the fuel passages parallel with the oxidant flowing in the oxidant passages, and the heat medium flows in the heat medium passages parallel with or counter to the fuel and the oxidant.

17. The fuel cell stack according to claim 11, further comprising a plurality of notches in at least one stack end member selected from a group of the current collector plate, the insulating plate and the end plate, in a direction perpendicular to the direction of flow of the heat medium flowing in the heat medium passage.

18. The fuel cell stack according to claim 11, further comprising a plurality of holes in at least one stack end member selected from a group of the current collector plate, the insulating plate and the end plate, along the flow of the heat medium flowing in the heat medium passage.

19. The fuel cell stack according to claim 11, wherein at least one stack end member selected from a group of the current collector plate, the insulating plate and the end plate, is divided into a plurality of pieces along the flow of the heat medium flowing in the heat medium passage.

20. A fuel cell stack comprising:
a stack comprising a plurality cells and a plurality of cooling plates each provided with a heat medium passage in which a heat medium for cooling the cell flows, each of the plurality of cells including:
a membrane and electrode assembly provided with an electrolyte, an anode provided at one face of the electrolyte, and a cathode provided at the other face of the electrolyte;
an anode plate provided with a fuel passage facing the anode; and
a cathode plate provided with an oxidant passage facing the cathode, the fuel cell stack further comprising:
an end plate provided at an end of the stack via a current collector plate and an insulating plate, so as to clamp the stack; and
a stack end passage which is provided in the end plate and is provided with an inlet through which the heat medium past the cooling plate flows to the end plate, and an outlet through which the heat medium is emitted outside the end plate, the heat medium flowing through the stack end passage, wherein
a distance from the inlet to the outlet in the direction of flow of the heat medium flowing in the stack end passage is equal to or greater than ¼ and equal to or smaller than ½ of a distance in the direction of flow of the heat medium in the electrolyte.

21. The fuel cell stack according to claim 20, further comprising a first flow rate control element that controls the flow rate of the heat medium flowing into the stack end passage in accordance with the temperature of the heat medium.

22. The fuel cell stack according to claim 20, further comprising a second flow rate control element for controlling the flow rate of the heat medium which flows into a cooling water emission manifold that establishes a passageway through the stack and communicates with the stack end passage, and which passes through the cooling plate provided at the end of the stack, in accordance with the temperature of the heat medium past the cooling plate.

23. The fuel cell stack according to claim 21, further comprising a second flow rate control element for controlling the flow rate of the heat medium which flows into a cooling water emission manifold that establishes a passageway through the stack and communicates with the stack end passage, and which passes through the cooling plate provided at the end of the stack, in accordance with the temperature of the heat medium past the cooling plate.

24. The fuel cell stack according to claim 20, wherein the heat transfer in the direction of flow of the heat medium flowing in the heat medium passage at portions of the end plate not provided with the stack end passage, is lower than the heat transfer in a direction perpendicular to the direction of flow of the heat medium flowing in the heat medium passage.

25. The fuel cell stack according to claim 20, wherein each of the fuel passage, the oxidant passage and the heat medium passage comprises a plurality of straight passages such that the fuel flows downward in the fuel passages parallel with the oxidant flowing in the oxidant passages, and the heat medium flows in the heat medium passages parallel with or counter to the fuel and the oxidant.

26. The fuel cell stack according to claim 20, further comprising a plurality of notches in at least one stack end member selected from a group of the current collector plate, the insulating plate and the end plate, in a direction perpendicular to the direction of flow of the heat medium flowing in the heat medium passage.

27. The fuel cell stack according to claim 20, further comprising a plurality of holes in at least one stack end member selected from a group of the current collector plate, the insulating plate and the end plate, along the flow of the heat medium flowing in the heat medium passage.

28. The fuel cell stack according to claim 20, wherein at least one stack end member selected from a group of the current collector plate, the insulating plate and the end plate, is divided into a plurality of pieces along the flow of the heat medium flowing in the heat medium passage.
